(19) United States
(12) Patent Application Publication
(10) Pub. No.: US 2014/0082108 A1
(43) Pub. Date: Mar. 20, 2014

(54) DIGITAL CLUB NETWORKS

(71) Applicant: Ehud Naamani, Ann Arbor, MI (US)

(72) Inventor: Ehud Naamani, Ann Arbor, MI (US)

(73) Assignee: Vadim Savvateev, Saint Paul, MN (US)

(21) Appl. No.: 14/027,095

(22) Filed: Sep. 13, 2013

Related U.S. Application Data
(60) Provisional application No. 61/701,010, filed on Sep. 14, 2012.

(51) Int. Cl. H04L 12/58

(52) U.S. Cl. CPC H04L 51/04
USPC 709/206

(57) ABSTRACT

Club networks include provider members of goods or services associated with platforms like automobiles, other vehicles, appliances or structures, and customer members. structures, and customer members. Customer members join a club by connecting an on-board-device, linked to the network through an interface like a smart phone. The club processes the data and delivers messages for the benefit of customer members, providing the advantages of social network with convenience, safety, commercial advantage and fun aspects of using the platform.

This application claims the benefit of U.S. Provisional Application No. 61/701,010, filed Sep. 14, 2012

### BACKGROUND

Businesses deliver marketing messages through general media advertisement, subject-matter based affiliation groups or membership programs. More efficient delivery of marketing messages is based on determination of a customer purchase readiness, actual needs and habits.

Retailers assess purchase readiness based on data collected through tracking the history of purchases linked to member accounts in membership databases, data collection and marketing message delivery occurring at the point of sale.

In the internet environment, retailers assess purchase readiness in real time based on data collected through tracking the history of word searches linked to user accounts in search engine provider databases, data collection and marketing message delivery through “pay-per-click” and like models thus being disconnected physically from brick-and-mortar point of sale.

### SUMMARY

The present disclosure describes a method for delivering targeted messages which comprises: creating a club network comprising a provider member and a plurality of customer members based on a subject matter related to a platform; monitoring a plurality of data elements representative of an operating state of the platform or actions of an operator of the platform during a selected period; consolidating selected ones of the plurality of data elements common to the club network, when the ones are determined to have a preselected relationship to the shared subject matter, into a status alert; transferring the status alert into a repository, processing the status alert or a plurality thereof by means of a plurality of computer executable instructions, to produce a message with content based on the status alert and on the subject matter; and communicating the message to a provider member or a customer member of the club network.

In one aspect of the disclosure, the subject matter is platform condition; and the selected ones are platform condition parameters collected from the platform on-board sensors and computers during a selected period. In another aspect of the disclosure, the provider member is the platform manufacturer, the platform servicing, maintenance or repair provider.

In yet another aspect of this disclosure, the method further comprises determining the platform location at the time the status alert is created, and optionally relating it to preferential pricing provided by the provider member for a service or an article supporting platform operation, or a combination thereof, available at a plurality of locations; the status alert indicates a need for selected items of the plurality of items; and the computer executable instructions generate a message comprising selected locations from the plurality of locations ranked by proximity to the platform location.

In another aspect of the present disclosure the subject matter is vehicle insurance, the selected ones being vehicle condition and driving parameters collected from vehicle on-board sensors and computers.

In another aspect of the present disclosure the subject matter is vehicle financing, the provider member is a lending party or a lessor, the customer member is borrowing party or a lessee, the selected ones may optionally comprise vehicle mileage or indicators of the vehicle mechanical condition or driving parameters, or the message comprises a statement reflecting lessee's projected compliance with the lease terms.

In a different aspect of the disclosure, the platform may be an appliance, a piece of industrial equipment, or structure, or a subject matter is automated transportation systems.

This disclosure also describes a system for carrying out the aforementioned method comprising an on-board unit for monitoring the plurality of data elements; means for consolidating selected ones of the plurality of data elements, into the status alert; a communication gateway for transferring the status alert into the repository; and means for communicating the message to the platform operator; wherein some of the instructions are deployed on a central processing unit or on a smart phone, or the on-board unit connected through an on-board diagnostic port whereby said system serves to connect customer members and provider members into a club network.

It is understood that other embodiments of the digital club network operating methods and systems will become readily apparent to those skilled in the art from the following detailed description, wherein it is shown and described only exemplary embodiments by way of illustration. As will be realized, the digital club network operating methods and systems are capable of other and different embodiments and its several details are capable of modification in various other respects. Accordingly, the drawings and detailed description are to be regarded as illustrative in nature and not as restrictive.

### BRIEF DESCRIPTION OF THE DRAWINGS

Throughout the specification reference is made to the appended drawings, where like reference numerals designate like elements, and wherein:

FIG. 1 is a diagram explaining the method and the system for delivering targeted messages to digital club network members.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present disclosure describes a method to deliver messages through the use of digital club networks formed around a shared subject matter related to a platform.

In the following description, reference is made to the accompanying drawing that forms a part hereof and in which a club network is shown by way of illustration. It is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Sequential numerals are used to distinguish between elements and steps, and do not suppose a sequence of appearance, assembly or execution, unless the content clearly dictates otherwise.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

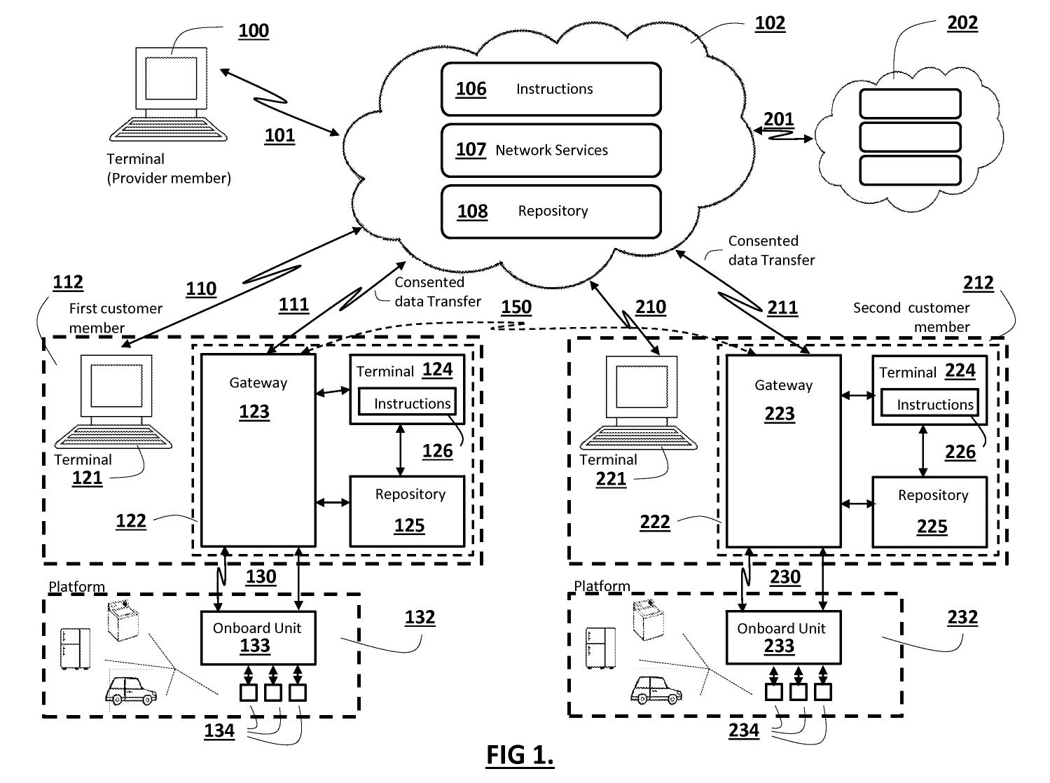

FIG. 1 is a diagram explaining the method for delivering targeted messages through a digital club network.

According to one aspect of the current disclosure, a digital club network, or a “club network” 202, is a networking framework including software and hardware components enabling communication between its nodes, or “members”. Communication encompasses exchange of data and messages. Messages encompass informative messages, notifications, alerts, reports, referrals, marketing offers, analytics, visual analytics and other forms of communications perceptible to humans.

Club Networks

Each club network is created around a defined subject matter.

In a preferred embodiment of the current disclosure, such subject matter is automobile use.

The subject matter is related to a technical platform, or a “platform” hereinafter. A platform is a device or article serving a useful function, e.g. an automobile in the aforementioned preferred embodiment. In other embodiments, platforms may be other types of vehicles, including but not limited to boats, airplanes, bicycles, motorcycles, specialty vehicles, and mobile homes, or non-vehicle devices such as: appliances including televisions, items of consumer electronics, computer equipment, printers, ovens, utility water heaters, air heaters, washers, dryers, industrial equipment, and tools. Further, customers and providers seeking to improve performance, efficiency, commerce and utility of structures and assets like houses, automated gates, road signs, beacons, navigation signage, various signal transmitters, pipes, cables, connector boxes, valves, compressors, generators, industrial equipment, foundations, load pillars and other articles equipped with sensors and on-board readout devices may form digital club networks in accordance with current disclosure.

A club network is composed of at least one provider of product/service that is related to a subject matter, a “provider member” hereinafter, and a plurality of customers interested in the subject matter and possibly in such product/service, “customer members” hereinafter.

The club networks of this disclosure are created by business actors, who in some cases may but do not have to be provider members of the club network.

The creator may further associate several club networks 202, or divide or regroup the clubs they control.

Customer members 112 and 212 have in their possession platforms 132 and 232, equipped with sensors and on-board computers 134 and 234 generating data elements representative of operating states of the platforms. These data elements are monitored and processed by the on-board units 133 and 233 and transferred through a wireless or wired link 130 and 230 to the interface units 122 and 222 respectively. Processing may include protocol changes.

Interface units 122 and 222 comprise optional terminals 124 and 224, optional repositories 125 and 225, and communication gateways 123 and 223 configured to receive the communications from the on-board units 133 and 233, respectively.

The data elements are consolidated into status alerts. “Consolidation” may take many forms. By a way of example, it may be as simple as selecting the data element, which had been determined to be of relevance to the subject matter of the club network, from the total plurality of data elements communicated by the on-board unit.

The consolidation of the data elements into status alerts may take place in the on-board units as part of the processing, in the gateways 123 and 223, in the associated terminals 124 and 224 respectively, or in a combination thereof. The content of a status alert is flexible and may be modified based on user input, pre-programmed executable instructions, subject matter or a combination of these inputs.

Data transfer from the on-board units to the interface units is subject to the ongoing automatic validation of consent from the respective customer members to share their data as indicated by their membership status 111 and 211.

The status alerts are then transferred into repositories, 125 or 225 and through communication channels 111 and 211 to repository 108; repositories 125 and 225 are physically located with the respective interface units, and repository 108 on a central processing unit 102.

A repository is an environment that allows collection and storage of all the data transferred, provides access to the data it holds as well as information services and functions that facilitate the development of computer executable instructions that relate to that data. Computer executable instructions 126, 226 and 106 operate on current data alerts and on those logged in repositories 125, 225 and 108 respectively, and may exchange data and additional messages between the three repositories.

Terminals 100, 121 and 221 are computer terminals with audio-visual capabilities known in the art, adapted to receive messages, to view the results generated by the executable instructions 106, and to interact with the executable instructions 106 and the central processing unit 102 through communication links 101, 110, 210. Messages generated by the executable instructions are communicated to customer members 112, 212 through communication channels 111 and 211 and the gateways 123 and 223. Customer members may use terminals 124 and 224 to receive messages, and to interact with the instructions on these terminals. The messages are expressed in human-perceptible form through the terminals.

The network services 107 of the central computing unit 102 enable club network interactions among its members, based on the data in the repositories and data these members may have from other sources, for them to satisfy their personal interests in the subject matter and receive the benefits of participating in that club network. It provides the services for all members of a club network to receive messages targeted at them, issue messages, respond to messages, access and review data and exchange information on the club network including and not limited to some of security services, privacy services per the policy specified, social networking services, and crowd sourcing services by way of examples.

Customer members consent to share certain data with other club members to receive targeted messages and other club benefits such as, but not limited to, social networking, commercial and subject matter related.

Accordingly, the status alerts, record of data elements, the selected ones, or combination thereof are communicated over the interface device gateway function, the function implemented as a combination of software and hardware, to a central processing unit with its owner's consent. The central processing unit administers network services 107, a repository for communications received from the customer members and provider members 108, and executable instructions to operate on them 106.

In one aspect of the current disclosure, executable instructions operate on the communications retained in the central repository 108 to generate actions by way of communications messages sent to customer members or to provider members.

In another aspect of the current disclosure, executable instructions located on the central processing unit process the log of communications from multiple customer members, and from provider members, in order to adjust the executable instructions deployed on a customer member's interface unit that could be a smart phone, thus reflecting knowledge generated from the cumulative data collected from the club membership to improve quality of services offered to the individual customer member.

The central processing unit with a set of executable instructions (software) deployed on it collects data from multiple gateways, stores it in the repository, and operates on this data to determine customer purchase readiness, customer needs, customer habits, club trends, and opportunities In one preferred embodiment, portions of this component comprise cloud based hardware or software application.

In yet another aspect of this disclosure, the club networks form social networks used for social interactions between their members topically related to the subject matter, e.g. recommendations, sharing of experiences, referrals, comparing prices and blogging. The functions of digital club network are provided by the network services 107 and direct communications between members through a direct communication channel 150.

### Example 1

### Automotive Club Network

In the aforementioned preferred embodiment, the subject matter is automobile use, the platforms being automobiles. The digital auto club network comprises automobile owners, drivers and providers of products or services associated with automobile use.

Customer members are in possession of the automobile by virtue of owning the automobile in whole or any interest in it, or by operating it or by being responsible for any aspect of its functionality or use which creates an incentive for them to join a club network and interest in services or articles pertaining to its use.

Provider members in club networks based on automobile use subject matter may be drawn from providers of products or services such as, but not limited to, insurance companies, auto repair and maintenance, new and used vehicle dealerships, professional membership organizations, travel agencies, financial institutions, transportation infrastructure or emergency services providers and responders. In accordance with this disclosure, data elements encompass a broad variety of data analogue or digital data, signals or readouts from sensors or computers integrated with, connected to, or obtaining information about the vehicle. These may be related to automobile operation, condition or data related to their use, bearing importance, alone or in combination with other data to possessors' purchasing readiness or needs.

A digital automotive club network is formed by distributing car on-board interface units with an associated set of instructions executable on these units or on an interface device like a smart phone (software “app” in the mobile communication parlance).

The plurality of data elements may be monitored through an on-board unit connectable to an automobile communication port. Since 1996 all vehicles sold in the USA include a communication port that is compliant with an SAE/ISO set of standards known as OBD (On Board Diagnostics) port, its common version being ODB-II. OBD ports support a set of protocols that convey operational information from the vehicle computer networks that connect between vehicle controllers, sensors and actuators. The port also enables interaction with the on-board diagnostics software which provides diagnostics information generated by that software in the form of related data elements.

The recipients join the pre-configured digital club network and provide consent to sharing the data from the automobile in their possession by electing to install the on-board units, to register and to use them and the software app provided with them. Customer members retain control allowing them to dissociate from the club through disconnecting the on-board units deployed in their platforms (vehicles), through instructing the software to dissociate from a specific club, through turning the gateway off, or through uninstalling software on the interface units (smart phones) under their control; they may retain an option to rejoin the club by reversing these actions. In another aspect of the disclosure, consent may be established by displaying messages on a driver information display provided inside the vehicle and giving members the option to opt-out. In yet another aspect of the invention, other suitable and acceptable means to obtain customer members' consent by their overt act may be utilized.

Maintaining a record of customer member consent with appropriate information describing the scope of the consent, e.g. its geographic, personalization or temporal scope and checking the data read from the on-board sensors is an important aspect of this disclosure. In one example, data obtained from an automobile position sensor may be categorized by the customer member as highly private and hence can be prevented from being released to other club members. In another example, once the clock indicates pre-set membership period expiration, the consent may be treated as invalid, and sharing of data prevented. In yet another example, the consent may be presumed, e.g. when the sensor or on-board computer generated data indicates that an emergency situation has occurred, and the absence of explicit consent is overridden to enable sharing the data for the purposes related with the emergency.

The digital automobile club network forms a community that is beneficial to the customer members in supporting their need to maintain and optimize their automobile operation, but also in enhancing commercial, social, and fun aspects of automobile ownership and use. The network utilizes information technologies to connect vehicles to their drivers or to other vehicles and their drivers, to create a mobility form of social networks that enables a new form of interactive marketing. Customer members may receive the on board unit as a promotional give away providing an incentive to join a digital club and enable sharing of data derived from their vehicles. Some of the club membership benefits to the vehicle owner are vehicle ownership with confidence from insurance to mechanical, fun driving with social interactions, peace of mind of a safer travel to self, the teenage and the elderly, reduction in operation costs, and the enhancement of the “cool factor”.

Illustrative examples of data elements which have a bearing to purchase readiness are, but not limited to, (a) oil level sensor readings: reading indicating engine oil level is below prescribed minimum indicates customer member's readiness to purchase oil change service; (b) airbag deployment status: indicated need for situation assessment by insurance provide or emergency services provider; (c) vehicle full stop status; (d) engine load stress; (e) engine temperature; (f) vehicle speed, mileage and location logs, and so on.

Dependent on club network manager or preferences of the creator of the club network, the on-board unit connected to the communication port on-board the vehicle may be configured to “consolidate” the data elements it reads out into a selected subset determined to be of importance to a subject matter of the club network. Thus, where the subject matter is auto insurance, the on-board unit may be configured to consolidate data referring to velocity, location and time logs, braking patterns and other risk-factor impacting use characteristics, in a certain frequency or based on certain events while transmitting status alerts of engine performance characteristics in other times or events (e.g. emergency). The data elements may be communicated from the on-board unit to an interface unit 122 and 222 and consolidated. The data may be analyzed by sets of executable instructions 126 and 226 deployed on the interface unit; the outcome of such analysis being determination of whether a message pertaining to the club network subject matter should be issued locally or to the central repository.

Data alerts transmitted to the central processing unit are analyzed by the set of executable instructions deployed on the central unit; the outcome of such analysis being determination of whether a message pertaining to the club network subject matter should be issued.

One example of such interface is a smart phone, hereinafter understood as a device combining computational capability, memory and a cellular communication function. Cellular communications have advanced to support data communications. These advances in the art enable using a cellular phone brought on board by the driver as the local computing and communication unit. In one preferred embodiment of auto club networks, a car interface protocol converter is connected to the standard OBD II port and is operational to convert the data from an OBD II protocols to a protocol used in smart phones.

Part of the Smart phone memory may be configured as a repository to maintain a record of data elements, the selected ones, the status alert or combination thereof. Moreover, cellular phones have advanced to include certain sensors like a GPS or acceleration sensors which are part of possible external sensors. In one aspect of the current disclosure, a set of instructions configured to be executable on the smart phone processor may be deployed to overlay the full stop status indicator communicated from the on-board unit to the smart phone onto the location data from the GPS sensor on the smart phone and the highway map stored in the smart phone memory to generate a status alert indicating an emergency stop on a highway, the subject matter being the emergency condition detection.

Another aspect of the disclosure is a central processing unit (102 and 202) that could reside in a cloud computing environment. This way the unit is always available to receive data from any computing unit that enters a connected mode. It can interact, two ways, with any executable computer instructions that may reside in different locations and based on the connectivity status of each customer member or its motion status.

In a particular embodiment of the disclosure, status alert indicative of emergency or road side condition may be processed into a message to an emergency services provider member, a message to the customer whose vehicle has been determined to had made an emergency stop with contact information for auto care provider members in locations proximate the stop location; and a message to other customer members determined to be located in the vicinity of the stop location.

### Example 2

### Forming a Club Network

Company A is in the business of providing services or products to a type of a platform that has built in computing unit and sensors. By way of example, such company might be an auto-care company, a car insurance provider or an HVAC (heating, ventilation and air conditioning) equipment or services provider. The company wishes to retain the current customers and to acquire new customers. During a service call and employee installs an onboard unit onto the platform with customer consent, in the auto care case this installation might be plugging the onboard unit into the OBD port in the car. In some cases an interface unit would be a smart phone. In other cases a specialized stand alone interface units would be installed. The owner is required to download a set of computer instructions and to register. With the on-board unit and the set of instructions installed the process of monitoring the data generated by the platform, consolidating some data elements into a status alerts and transferring them to repository associated with the customer member and the club networks he/she selected would commence.

Data is collected on periodic basis. For the HVAC case it might be whenever the system is turned on or only during day time.

### Example 2.1

### Membership Status Monitoring

A set of executable instructions reviews and analyzes the incoming status alerts. Each status alert received into the repository provides an indication that the owner of the specific source of data can be counted as an active customer. Absence of status alerts for a period greater than the typical determined from the history log for the owner indicates this owner is no longer a customer. Accordingly, the provider member can view the accurate status of each owner membership at any time. A message is issued to the provider member whenever a customer is turns non-active. The provider member may relate this message to an action to send that customer an incentive to rejoin its digital club in a message that is than sent to that customer. A message is issued to the provider member when a new member becomes active. The company could relate this message to a club-wide message introducing that customer to the membership or to an action to publish a personal page on the club network for the new customer and the platform it owns.

### Example 2.2

### Insurance

A set of executable instructions operates to review and analyze the status alerts to identify driving parameters indicative of certain behaviors of the customer member. An insurance company, the provider member, might consider driving after midnight, hard breaking or traveling at a speed higher than other peers on the same road as increased risk. When such increased-risk behavior is identified, the driver receives a message and may elect to correct. Each correction reduces the total risk and hence statistically improves the claim ratio for the insurance company. A message can be sent to all other customer members in the related area so they can offer their help or advice.

Further, identification of a behavior associated with risk as perceived by the provider member could result in a message to a customer member who is the parent of a teenage driver or is a relative of an elderly driver, alerting the customer member even though the customer member is not currently driving the specific car.

In another particular example a customer member who is an employer would be alerted when a risky behavior by an employee who drives the vehicle is detected.

### Example 2.3

### Auto Care

Similarly to Example 2.2, the driving pattern is analyzed to identify aggressive driving. However, in this case such identification triggers a service offering. Driving parameters that indicate an aggressive driver result in a message to the auto care provider member. The provider member could use it to trigger a message to the consumer member with an explanation of the benefits of certain oil or gas additives and a financial incentive to come perform the service. The provider can examine the spread of that behavior among its members to determine the preferred action. The member who receives the message can open a club discussion with other members about the benefits of the recommendation.

### Example 2.4

### HVAC

A set of computer instruction is operational to search the status alerts for exceptions. Status alerts indicating detected exceptions like open window/door and HVAC set to cooling can be used to send messages to a customer member, e.g. a landlord, who can share his/hers experience with other club members seeking their opinion of how to handle a pet that need to go out to the yard or young kids on summer vacation. A deviation from a cooling pattern under similar parameter like “no open window” may trigger a message calling for a need for HVAC equipment maintenance procedure.

Following is a list of illustrative embodiments of the present disclosure.

Item 1 is a method for delivering targeted messages, comprising: creating a club network comprising a provider member and a plurality of customer members based on a subject matter related to a platform; monitoring a plurality of data elements representative of an operating state of the platform or actions of an operator of the platform during a selected period; consolidating selected ones of the plurality of data elements common to the club network, when the ones are determined to have a preselected relationship to the shared subject matter, into a status alert; transferring the status alert into a repository, processing the status alert or a plurality thereof by means of a plurality of computer executable instructions, to produce a message with content based on the status alert and on the subject matter; and communicating the message to the provider member or a customer member of the club network.

Item 2 is the method of item 1, wherein: the subject matter is platform condition; and

the selected ones are platform condition parameters collected from the platform on-board sensors and computers during a selected period.

Item 3 is the method of item 2, wherein the provider member is the platform manufacturer.

Item 4 is the method of item 2, wherein the provider member is the platform servicing, maintenance or repair provider.

Item 5 is the method of item 1, further comprising determining the platform location at the time the status alert is created.

Item 6 is the method of item 5, wherein: the subject matter is preferential pricing provided by the provider member for an item, the item being a service or an article supporting platform operation, or a combination thereof, available at a plurality of locations; the status alert indicates a need for selected items of the plurality of items; and the computer executable instructions generate a message comprising selected locations from the plurality of locations ranked by proximity to the platform location.

Item 7 is the method of item 1, wherein the platform is a vehicle.

Item 8 is the method of item 7, wherein the selected ones comprise the data element indicating airbag deployment.

Item 9 is the method of item 7, wherein the selected ones comprise the data element indicating the vehicle full stop.

Item 10 is the method of item 7, wherein the computer executable instructions determine whether the vehicle is positioned on a highway.

Item 11 the method of item 7, wherein the subject matter is the vehicle insurance, the selected ones being vehicle condition or driving parameters collected from the vehicle on-board sensors and computers.

Item 12 is the method of item 7, wherein the subject matter is the vehicle financing, the provider member is a lending party or a lessor, the customer member is borrowing party or a lessee.

Item 13 is the method of item 12, wherein the selected ones comprise vehicle mileage.

Item 15 is the method of item 12, wherein the selected ones comprise driving parameters.

Item 17 is the method of item 12, wherein the message comprises a statement reflecting lessee's projected compliance with the lease terms.

Item 18 the method of item 1, wherein the platform is an appliance.

Item 19 the method of item 1, wherein the subject matter is automated transportation systems.)

Item 20 is the method of item 1, wherein the platform is a piece of industrial equipment.

Item 23 is the system of item 21, wherein the on-board unit connects through an on-board diagnostic port.

Item 24. The system of item 21, wherein the interface device is a smart phone, the smart phone being configured to receive the status alert the selected ones from the on-board unit.

Item 25 is the system of item 21, wherein an instruction from the plurality is executed on a smart phone.

Item 26 is a computer-readable storage device, containing a set of instructions that causes the smart phone and the central processing unit to perform a method of item 1.

What is claimed is:

1. A method for delivering targeted messages, comprising:
creating a club network based on a subject matter related to a platform, comprising
a provider member, and
a plurality of customer members;
monitoring a plurality of data elements representative of an operating state of the platform or actions of an operator of the platform during a selected period;
consolidating selected ones of the plurality of data elements common to the club network, when the selected ones are determined to have a preselected relationship to the shared subject matter, into a status alert;
transferring the status alert into a repository;
processing the status alert or a plurality thereof by means of a plurality of computer executable instructions, into a message with content based on the status alert and on the subject matter; and
communicating the message to the provider member or a customer member of the club network.

2. The method of claim 1, wherein:
the subject matter is platform condition; and
the selected ones are platform condition parameters collected from the platform on-board sensors and computers during a selected period.

3. The method of claim 2, wherein the provider member is the platform manufacturer.

4. The method of claim 2, wherein the provider member is the platform servicing, maintenance or repair provider.

5. The method of claim 1, wherein the selected ones comprise the platform location.

6. The method of claim 5, wherein:
the subject matter is preferential pricing provided by the provider member for an item, the item being a service or an article supporting platform operation, or a combination thereof, available at a plurality of locations;
the status alert indicates a need for the item; and
the computer executable instructions generate a message comprising selected locations from the plurality of locations ranked by proximity to the platform location.

7. The method of claim 1, wherein the platform is a vehicle.

8. The method of claim 7, wherein the subject matter is the vehicle insurance, the selected ones being the data elements indicative of the vehicle condition or of driving style collected from the vehicle on-board sensors and computers.

9. The method of claim 7, wherein the subject matter is the vehicle financing, the provider member is a lending party or a lessor, the customer member is borrowing party or a lessee.

10. The method of claim 9, wherein the selected ones comprise data elements indicative of the vehicle mileage.

11. The method of claim 7, wherein the selected ones comprise data elements indicative of the vehicle mechanical condition.

12. The method of claim 9, wherein the message comprises a statement reflecting lessee's projected compliance with the lease terms.

13. The method of claim 1, wherein the platform is an appliance.

14. The method of claim 1, wherein the subject matter is automated transportation systems.

15. The method of claim 1, wherein the platform is a piece of industrial equipment.

16. A system for carrying out the method of claim 1, comprising:
an on-board unit for monitoring the plurality of data elements;
means for consolidating selected ones of the plurality of data elements into the status alert;
a central processing unit; and
an interface device comprising:
a gateway adapted to exchange the data elements, the status alerts and the messages with the on-board unit, the repository or the central processing unit;
optionally, the repository; and
optionally, a terminal adapted to exchange data elements and status alerts with the repository or with the central processing unit.

17. The system of claim 16, wherein a computer executable instruction from the plurality is executed on the central processing unit.

18. The system of claim 16, wherein the on-board unit connects through an on-board diagnostic port.

19. The system of item 16, wherein a computer executable instruction from the plurality is executed on the interface device.

20. A computer-readable storage device, containing a set of executable instructions for operating the system of claim 16.
